(19) United States
(12) Patent Application Publication
(10) Pub. No.: US 2026/0248686 A1
(43) Pub. Date: Aug. 27, 2026

(54) Pain Relief Hand Tool Device

(71) Applicant: Betsy Zimmerman, Indianapolis, IN (US)

(72) Inventor: Betsy Zimmerman, Indianapolis, IN (US)

(21) Appl. No.: 19/453,004

(22) Filed: Jan. 20, 2026

Related U.S. Application Data
(60) Provisional application No. 63/761,236, filed on Feb. 21, 2025.

(51) Int. Cl. A61H 39/04

(52) U.S. Cl. CPC A61H 39/04; A61H 2201/0153; A61H 2201/1635; A61H 2201/1695; A61H 2203/0475; A61H 2205/065; A61H 2205/108; A61H 2205/12

(57) ABSTRACT

A pain relief hand tool device is disclosed, which is a series of hand tools for promoting healing. The pain relief hand tool device comprises an elongated handle component with a head component. The handle component is available in three different designs that can be applied to different areas of the body with ease. The head component is typically either round or rectangular-shaped. The head component also comprises nails or sharp points arranged to apply pressure to the skin but not puncture it. Users can choose a desired tool design and apply it to the body. The pressure applied can help relieve aches and pains, reduce stress, reduce inflammation, promote better cell health, improve circulation, etc.

### CROSS REFERENCE TO RELATED APPLICATION

The present application claims priority to, and the benefit of, U.S. Provisional Application No. 63/761,236, which was filed on Feb. 21, 2025, and is incorporated herein by reference in its entirety.

### FIELD OF THE INVENTION

The present invention relates generally to the field of pain relief hand tool devices. More specifically, the present invention relates to a hand tool that can bring immediate relief to aching joints, muscles, and bones. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pain relief hand tool devices. Generally, people suffering from aches and pains may be unable to find relief unless they opt for medication. However, some people may not want to take medication daily to obtain pain relief. Further, being reliant on substances can lead to addiction and long-term negative side effects on the body.

Additionally, those suffering from aches and pains may have trouble sleeping and getting a full night's rest. Extreme fatigue can lead to poor performance throughout the day, especially for people with busy schedules.

Accordingly, there is a demand for an improved pain relief hand tool device that offers a natural alternative to medications for relieving aches, pains, and more. More particularly, there is a demand for a pain relief hand tool device that can bring immediate relief to aching joints and muscles.

Therefore, there exists a long-felt need in the art for a pain relief hand tool device that provides users with hand tools that can bring immediate relief to aching joints, muscles, and bones. There is also a long-felt need in the art for a pain relief hand tool device that features three differently configured tools for application to various areas of the body. Further, there is a long-felt need in the art for a pain relief hand tool device that includes a tool head featuring nails or sharp points that do not puncture the skin. Moreover, there is a long-felt need in the art for a device that allows users to apply the tool head to the skin and press down to obtain instant relief. Further, there is a long-felt need in the art for a pain relief hand tool device that helps relieve pressure and stress, decrease inflammation, promote health at the cellular level, improve circulation, and more. Finally, there is a long-felt need in the art for a pain relief hand tool device that offers a natural alternative to medications for relieving aches, pains, and more.

The subject matter disclosed and claimed herein, in one embodiment thereof, comprises a pain relief hand tool device. The device is a series of hand tools for promoting healing including pain relief, reduced inflammation, cell restoration, etc. The pain relief hand tool device comprises an elongated handle component with a head component. The handle component is available in three different designs that can be applied to different areas of the body with ease. The head component is typically either round or rectangular-shaped. The head component also comprises nails or sharp points arranged to apply pressure to the skin but not puncture it. Users can choose a desired tool design and apply it to the body. The pressure applied can help relieve aches and pains, reduce stress, reduce inflammation, promote better cell health, improve circulation, etc.

In this manner, the pain relief hand tool device of the present invention accomplishes all of the foregoing objectives and provides users with a device that can bring immediate relief to aching joints, muscles, and bones. The device is a hand tool that promotes healing. The device is available in three different variations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pain relief hand tool device. The device is a series of hand tools for promoting healing including pain relief and inflammation. The pain relief hand tool device comprises an elongated handle component with a head component having nails or sharp points arranged to apply pressure to the skin. The pressure applied can help relieve aches and pains, reduce stress, reduce inflammation, promote better cell health, improve circulation, etc.

In one embodiment, the pain relief hand tool device provides users with hand tools that promote healing. The device allows users to apply the tool head to a user's skin and press down to obtain instant relief. Thus, the pain relief hand tool device helps relieve pressure and stress and offers a natural alternative to medications for relieving aches and pains.

In one embodiment, the pain relief hand tool device comprises a series of hand tools for promoting healing including pain relief, reduced inflammation, cell restoration, etc. The device can be used while standing, sitting down, and especially while lying in bed to help alleviate symptoms of throbbing pain, deep bone ache, and joint stiffness, etc.

In one embodiment, the pain relief hand tool device comprises an elongated handle component. The elongated handle component comprises a first end and a second end. Typically, the first end is secured to a head component and during use, a user retains the second end area within their hand. The elongated handle component is typically cylindrical in shape and can be of varying diameters and lengths depending on the needs and/or wants of a user. Further, the elongated handle component can also be curved at portions or narrowed at the ends, etc., depending on the wants and/or needs of a user.

In one embodiment, the handle component is secured to a head component via adhesives, glue, pins, screws, etc., or any other suitable securing means as is known in the art. The head component is typically either round or rectangular-shaped but can be any suitable shape as is known in the art, such as oval, square, etc. Typically, the head component comprises a front side and a back side. The back side is secured to the first end of the handle component via the securing means. The front side of the head component comprises a plurality of nails or sharp points arranged around the head component and extending outward from the front side. When the plurality of nails or sharp points are pressed against a user's skin, they act to apply pressure to the skin but do not puncture it.

In one embodiment, the pain relief hand tool device is available in three different designs that can be applied to different areas of the body with ease. In the first design, the handle component measures approximately 12 to 15 inches long, 1 inch wide, and 0.5 inch thick with a curve in the handle component and with the second end having a width of approximately 2.25 inches. The second design measures approximately 6 to 7 inches long with the first end having a head component with a rectangular shape measuring 4 inches by 2 inches. The third design includes a 4 to 5 inch long handle component with a round head component measuring 1.25 inches in width. However, any suitable design can be utilized depending on the needs and/or wants of a user.

In one embodiment, in use, users can choose a desired tool design of the pain relief hand tool device and apply it to their body. The device design can be chosen based on the part of the user's body that has aches and pains or joint stiffness, etc., and the wants and/or needs of a user. The pressure applied via the plurality of nails or sharp points of the pain relief hand tool device can help relieve aches and pains, reduce stress, reduce inflammation, promote better cell health, improve circulation, etc.

In one embodiment, the handle component comprises gripping texture areas or other suitable non-slip resistant areas to provide a non-slip grip for a user or any other suitable ergonomic grip, texture, coating, etc., to allow a user to securely and comfortably retain the device within their hand. Additionally, the handle component can also be curved or rounded, or otherwise ergonomically shaped to allow the user to more easily reach parts of their body that are in pain with the head component of the device, when in use.

In one embodiment, the pain relief hand tool device is manufactured from a durable plastic material or other suitable materials as is known in the art, or a combination of such materials.

In yet another embodiment, the pain relief hand tool device comprises a plurality of indicia.

In yet another embodiment, a method of relieving pain via applying pressure is disclosed. The method includes providing a pain relief hand tool device comprising a handle component with a head component. The method also comprises choosing one of three designs for the hand tool device. Further, the method comprises applying the head component of the device to an area of the user's body which has pain. The method also comprises pressing the head component to a user's skin, such that the sharp points apply pressure to the skin but don't puncture it. Finally, the method comprises relieving aches and pains via the pressure from the hand tool device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pain relief hand tool device of the present invention in accordance with the disclosed architecture;

FIG. 2 illustrates a perspective view of one embodiment of the pain relief hand tool device of the present invention showing the three different configurations in accordance with the disclosed architecture;

FIG. 3 illustrates a perspective view of one embodiment of the pain relief hand tool device of the present invention showing the first version of the device applied to a user's foot in accordance with the disclosed architecture;

FIG. 4 illustrates a perspective view of one embodiment of the pain relief hand tool device of the present invention showing the second version of the device applied to a user's thigh in accordance with the disclosed architecture;

FIG. 5 illustrates a perspective view of one embodiment of the pain relief hand tool device of the present invention showing the third version of the device applied to a user's hand in accordance with the disclosed architecture; and

FIG. 6 illustrates a flowchart showing the method of relieving pain via applying pressure in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pain relief hand tool device that provides users with hand tools that can bring immediate relief to aching joints, muscles, and bones. There is also a long-felt need in the art for a pain relief hand tool device that features three differently configured tools for application to various areas of the body. Further, there is a long-felt need in the art for a pain relief hand tool device that includes a tool head featuring nails or sharp points that do not puncture the skin. Moreover, there is a long-felt need in the art for a device that allows users to apply the tool head to the skin and press down to obtain instant relief. Further, there is a long-felt need in the art for a pain relief hand tool device that helps relieve pressure and stress, decrease inflammation, promote health at the cellular level, improve circulation, and more. Finally, there is a long-felt need in the art for a pain relief hand tool device that offers a natural alternative to medications for relieving aches, pains, and more.

The present invention, in one exemplary embodiment, is a novel pain relief hand tool device. The device is a series of hand tools for promoting healing. The pain relief hand tool device comprises an elongated handle component with a head component. The handle component is available in three different designs that can be applied to different areas of the body with ease. The head component is typically either round or rectangular-shaped. The head component also comprises nails or sharp points arranged to apply pressure to the skin but not puncture it. Users can choose a desired tool design and apply it to the body. The pressure applied can help relieve aches and pains, reduce stress, reduce inflammation, promote better cell health, improve circulation, etc. Further, the application discloses a novel method of relieving pain via applying pressure. The method includes providing a pain relief hand tool device comprising a handle component with a head component. The method also comprises choosing one of three designs for the hand tool device. Further, the method comprises applying the head component of the device to an area of the user's body which has pain. The method also comprises pressing the head component to a user's skin, such that the sharp points apply pressure to the skin but don't puncture it. Finally, the method comprises relieving aches and pains via the pressure from the hand tool device.

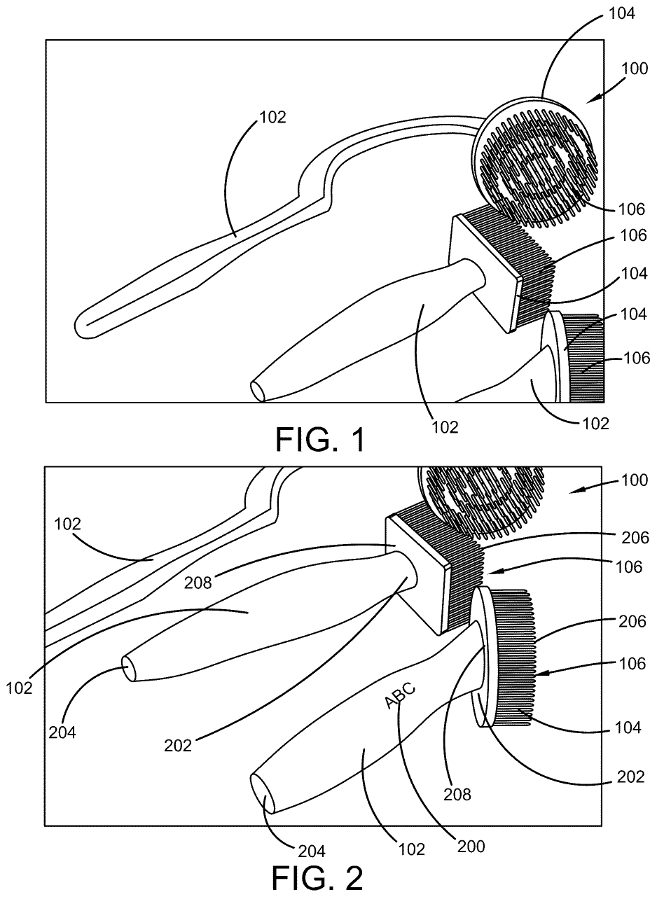

Referring initially to the drawings, FIG. 1 illustrates a perspective view of one embodiment of the pain relief hand tool device 100 of the present invention. In the present embodiment, the pain relief hand tool device 100 is an improved pain relief hand tool device 100 that provides a user 110 with hand tools that bring immediate relief to aching joints and muscles. Specifically, the pain relief hand tool device 100 comprises a handle component 102 with a head component 104 having nails or sharp points 106 arranged to apply pressure to the skin 108. The pressure applied can help relieve aches and pains, reduce stress, reduce inflammation, promote better cell health, improve circulation, etc.

Generally, the pain relief hand tool device 100 provides users with hand tools that promote healing. The device 100 allows users 110 to apply the tool head 104 to a user's skin 108 and press down to obtain instant relief. Thus, the pain relief hand tool device 100 helps relieve pressure and stress and offers a natural alternative to medications for relieving aches and pains.

Further, the pain relief hand tool device 100 comprises a series of hand tools for promoting healing including pain relief, reduced inflammation, cell restoration, etc. The device 100 can be used while standing, sitting down, and especially while lying in bed to help alleviate symptoms of throbbing pain, deep bone ache, and joint stiffness, etc.

As shown in FIG. 2, the pain relief hand tool device 100 comprises an elongated handle component 102. The elongated handle component 102 comprises a first end 202 and a second end 204. Typically, the first end 202 is secured to a head component 104 and during use, a user 110 retains the second end 204 area within their hand. The elongated handle component 102 is typically cylindrical in shape and can be of varying diameters and lengths depending on the needs and/or wants of a user 110. Further, the elongated handle component 102 can also be curved at portions or narrowed at the ends, etc., depending on the wants and/or needs of a user 110.

Further, the handle component 102 is secured to a head component 104 via adhesives, glue, pins, screws, etc., or any other suitable securing means as is known in the art. The head component 104 is typically either round or rectangular-shaped but can be any suitable shape as is known in the art, such as oval, square, etc. Typically, the head component 104 comprises a front side 206 and a back side 208. The back side 208 is secured to the first end 202 of the handle component 102 via the securing means. The front side 206 of the head component 104 comprises a plurality of nails or sharp points 106 arranged around the head component 104 and extending outward from the front side 206. When the plurality of nails or sharp points 106 are pressed against a user's skin 108, they act to apply pressure to the skin 108 but do not puncture it.

Additionally, in one embodiment, the handle component 102 comprises gripping texture areas 210 or other suitable non-slip resistant areas to provide a non-slip grip for a user 110 or any other suitable ergonomic grip, texture, coating, etc., to allow a user 110 to securely and comfortably retain the device 100 within their hand. Additionally, the handle component 102 can also be curved or rounded, or otherwise ergonomically shaped to allow the user 110 to more easily reach parts of their body that are in pain with the head component 104 of the device 100, when in use.

In yet another embodiment, the pain relief hand tool device 100 comprises a plurality of indicia 200. The handle component 102 of the device 100 may include advertising, a trademark, or other letters, designs, or characters, printed, painted, stamped, or integrated into the handle component 102, or any other indicia 200 as is known in the art. Specifically, any suitable indicia 200 as is known in the art can be included, such as, but not limited to, patterns, logos, emblems, images, symbols, designs, letters, words, characters, animals, advertisements, brands, etc., that may or may not be pain relief, hand tool, or brand related.

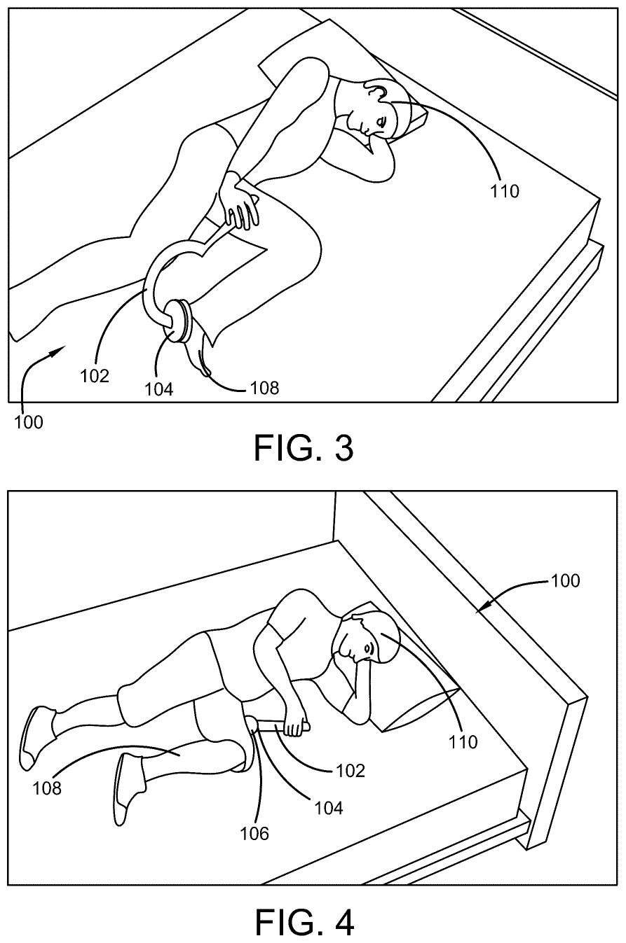

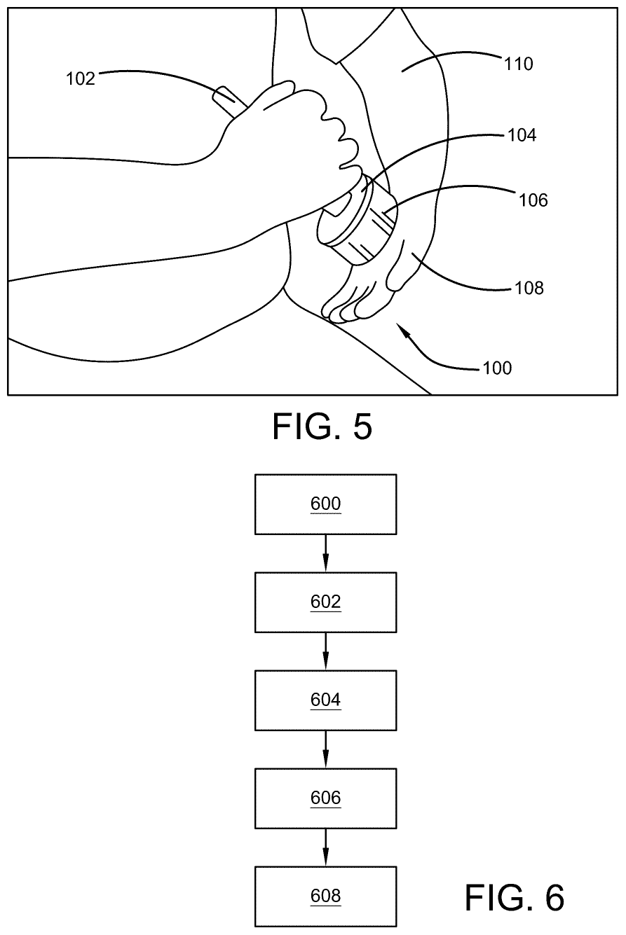

As shown in FIGS. 3-5, the pain relief hand tool device 100 is available in three different designs that can be applied to different areas of the body with ease. In the first design, the handle component 102 measures approximately 12 to 15 inches long, 1 inch wide, and 0.5 inch thick with a curve in the handle component 102 and with the second end 204 having a width of approximately 2.25 inches. The second design measures approximately 6 to 7 inches long with the first end 202 having a head component 104 with a rectangular shape measuring 4 inches by 2 inches. The third design includes a 4 to 5 inch long handle component 102 with a round head component 104 measuring 1.25 inches in width. However, any suitable design can be utilized depending on the needs and/or wants of a user 110.

In use, users 110 can choose a desired tool design of the pain relief hand tool device 100 and apply it to their body. The device 100 design can be chosen based on the part of the user's body that has aches and pains or joint stiffness, etc., and the wants and/or needs of a user 110. The pressure applied via the plurality of nails or sharp points 106 of the pain relief hand tool device 100 can help relieve aches and pains, reduce stress, reduce inflammation, promote better cell health, improve circulation, etc.

Generally, the pain relief hand tool device 100 is manufactured from a durable plastic material or other suitable materials as is known in the art, or a combination of such materials. Specifically, the pain relief hand tool device 100 can be manufactured from heat-sealable plastic or polymers, such as polyurethane or acrylonitrile-butadiene-styrene (ABS), or any other suitable material as is known in the art, such as, but not limited to, acrylic, polycarbonate, polyvinyl chloride, polystyrene, etc. Generally, the pain relief hand tool device 100 is also manufactured from a material that is water resistant or waterproof, or comprises a coating that is water resistant or waterproof. Further, the pain relief hand tool device 100 can be made of antibacterial or antimicrobial material or comprises a coating that is antibacterial or antimicrobial.

FIG. 6 illustrates a flowchart of the method of relieving pain via applying pressure. The method includes at 600, providing a pain relief hand tool device comprising a handle component with a head component. The method also comprises at 602, choosing one of three designs for the hand tool device. Further, the method comprises at 604, applying the head component of the device to an area of the user's body which has pain. The method also comprises at 606, pressing the head component to a user's skin, such that the sharp points apply pressure to the skin but don't puncture it. Finally, the method comprises at 608, relieving aches and pains via the pressure from the hand tool device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein, “pain relief hand tool device”, “hand tool device”, “pain relief device”, and “device” are interchangeable and refer to the pain relief hand tool device 100 of the present invention.

Notwithstanding the foregoing, the pain relief hand tool device 100 of the present invention can be of any suitable size and configuration as is known in the art without affecting the overall concept of the invention, provided that it accomplishes the above-stated objectives. One of ordinary skill in the art will appreciate that the pain relief hand tool device 100, as shown in FIGS. 1-6 is for illustrative purposes only, and that many other sizes and shapes of the pain relief hand tool device 100 are well within the scope of the present disclosure. Although the dimensions of the pain relief hand tool device 100 are important design parameters for user convenience, the pain relief hand tool device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pain relief hand tool device that provides a user with hand tools that bring immediate relief to aching joints and muscles, the pain relief hand tool device comprising:
a handle component; and
a head component;
wherein the head component is secured to the handle component;
wherein the head component comprises a plurality of sharp points for applying pressure to a user's skin; and
further wherein the pressure applied helps relieve aches and pains, improve circulation, reduce stress and inflammation and promote better cell health.

2. The pain relief hand tool device of claim 1, wherein the pain relief hand tool device comprises a series of hand tools for promoting healing.

3. The pain relief hand tool device of claim 2, wherein the pain relief hand tool device can be used while standing, sitting down, and especially while lying in bed to help alleviate symptoms of throbbing pain, deep bone ache, and joint stiffness.

4. The pain relief hand tool device of claim 3, wherein the handle component is an elongated handle component comprising a first end and a second end.

5. The pain relief hand tool device of claim 4, wherein the first end is secured to the head component and during use, a user retains the second end within their hand.

6. The pain relief hand tool device of claim 5, wherein the elongated handle component is typically cylindrical in shape and can be of varying diameters and lengths.

7. The pain relief hand tool device of claim 6, wherein the head component is typically either round or rectangular-shaped but can be other shapes, as well.

8. The pain relief hand tool device of claim 7, wherein the head component comprises a front side and a back side.

9. The pain relief hand tool device of claim 8, wherein the back side is secured to the first end of the handle component via a securing means.

10. The pain relief hand tool device of claim 9, wherein the front side of the head component comprises the plurality of sharp points arranged around the head component and extending outward from the front side.

11. The pain relief hand tool device of claim 10, wherein when the plurality of sharp points are pressed against a user's skin, they act to apply pressure to the user's skin but do not puncture it.

12. A pain relief hand tool device that provides a user with hand tools that bring immediate relief to aching joints and muscles, the pain relief hand tool device comprising:
an elongated handle component comprising a first end and a second end; and
a head component that is round or rectangular in shape and comprises a front side and a back side;
wherein the back side of the head component is secured to the first end of the elongated handle component via a securing means;
wherein the front side of the head component comprises a plurality of sharp points for applying pressure to a user's skin but not puncturing it; and
further wherein the pressure applied helps relieve aches and pains, improve circulation, reduce stress and inflammation and promote better cell health.

13. The pain relief hand tool device of claim 12, wherein the elongated handle component comprises gripping texture areas to provide a non-slip grip for a user.

14. The pain relief hand tool device of claim 12 further comprising a plurality of indicia.

15. The pain relief hand tool device of claim 12, wherein in one embodiment, the elongated handle component measures approximately 12 to 15 inches long, 1 inch wide, and 0.5 inch thick with a curve in the elongated handle component and with the second end having a width of approximately 2.25 inches.

16. The pain relief hand tool device of claim 12, wherein in another embodiment, the elongated handle component measures approximately 6 to 7 inches long with the first end having a head component with a rectangular shape measuring 4 inches by 2 inches.

17. The pain relief hand tool device of claim 12, wherein in yet another embodiment, the elongated handle component measure approximately 4 to 5 inches long and includes a round head component measuring approximately 1.25 inches in width.

18. The pain relief hand tool device of claim 12, wherein the pain relief hand tool device can be used while standing, sitting down, and especially while lying in bed to help alleviate symptoms of throbbing pain, deep bone ache, and joint stiffness.

19. The pain relief hand tool device of claim 12, wherein the pain relief hand tool device is manufactured from a durable plastic material or a combination of such materials.

20. A method of relieving pain via applying pressure, the method comprising the following steps:
providing a pain relief hand tool device comprising a handle component with a head component;
choosing one of three designs for the hand tool device;
applying the head component of the device to an area of the user's body which has pain;
pressing the head component to a user's skin, such that the sharp points apply pressure to the skin but don't puncture it; and
relieving aches and pains via the pressure from the hand tool device.
